(19) United States
(12) Patent Application Publication
(10) Pub. No.: US 2008/0014562 A1
(43) Pub. Date: Jan. 17, 2008

(54) CRYSTAL BALL ENCLOSURE STRUCTURE

(76) Inventor: Kun-Jou Hsieh, Kaohsiung City (TW)

Correspondence Address: LEONG C LEI, PMB # 1008, 1867 YGNACIO VALLEY ROAD, WALNUT CREEK, CA, 94598, US

(21) Appl. No.: 11/456,572

(22) Filed: Jul. 11, 2006

(51) Int. Cl. G09B 19/00

(52) U.S. Cl. 434/106

(57) ABSTRACT

A crystal ball enclosure is disclosed. The enclosure comprises a housing having at least one spherical chamber, at least one crystal ball and rib rim as the spherical chamber holding the crystal ball, characterized in that the interior face of the spherical chamber is provided with a slot, and the rib rim is strong and is formed as one unit and is firmly compressed at the largest diameter of the crystal ball and the crystal ball with the rib rim is placed in the slot of the spherical chamber.

### BACKGROUND OF THE INVENTION

a. Technical Field of the Invention

The present invention relates to crystal ball enclosure, and in particular, a crystal ball mounted with a gripping rim to permanently compressed the crystal ball.

b. Description of the Prior Art

Conventional crystal ball enclosure includes an external housing and at least a crystal ball, wherein the external housing includes at least a spherical chamber having an internal face being formed into a circular rib. The diameter of the circular rib is smaller than the external diameter of the crystal ball. When the crystal ball is within the spherical chamber and covered, the circular rib compresses the exterior of the crystal ball and is firmly contact with the crystal ball. The pressure caused by the rib and the resistance of the crystal ball cause the crystal ball to generate constant changes and a stable frequency. (This will influence current of the power supply to be stable and improve the impulse and noise of the electrical loops which allows smooth operation of the micro-computer of the vehicle and the fuel consumption of the vehicle is reduced.

However, due to the face that the crystal ball enclosure is mounted within the engine chamber, the impact of heat of the external housing will cause a change in the shape of the rib. Further, the extended long period of high temperature will cause the material of the rib becomes fatigue and the effect of the rib on the crystal ball is poor.

Accordingly, it is an object of the present invention to provide a crystal ball enclosure which mitigate the above drawbacks.

### SUMMARY OF THE INVENTION

The primary purpose of the present invention is to provide a crystal ball enclosure comprising a housing having at least one spherical chamber, at least one crystal ball and rib rim as the spherical chamber holding the crystal ball, characterized in that the interior face of the spherical chamber is provided with a slot, and the rib rim is strong and is formed as one unit and is firmly compressed at the largest diameter of the crystal ball and the crystal ball with the rib rim is placed in the slot of the spherical chamber.

Yet still another object of the present invention to provide a crystal ball enclose which can be easily installed and can maintained the stability of the crystal ball.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a crystal ball enclosure of the present invention.

FIG. 2 is an exploded perspective view of the crystal ball enclosure of the present invention.

FIG. 3 is a sectional view of the crystal ball enclosure of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

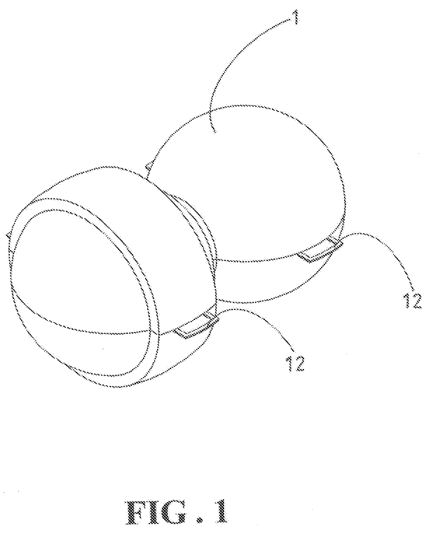

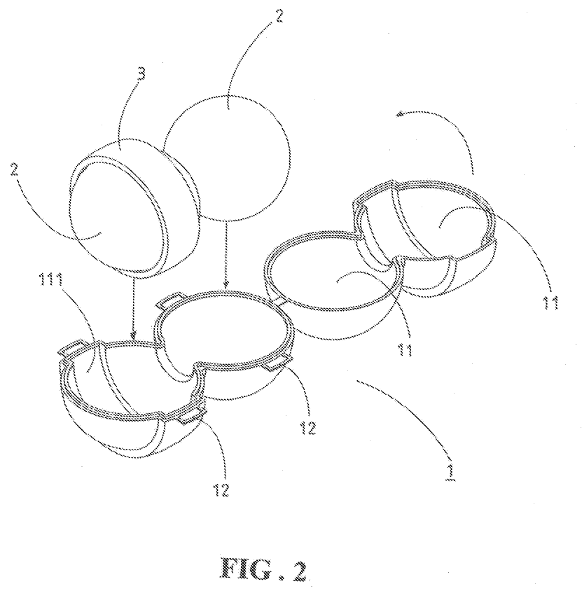

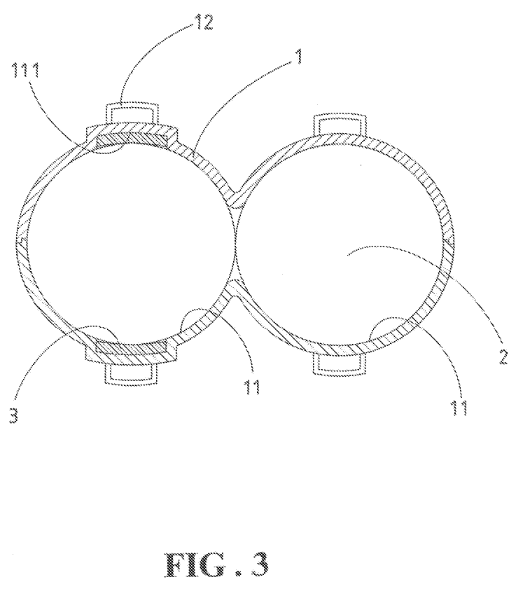

Referring to FIGS. 1, 2, and 3, there is shown a crystal ball enclosure of the present invention comprising a housing 1, at least one crystal ball 2 and a rib rim 3. The housing 1 includes two symmetrical shells which can hold two crystal ball 2. When the two shells of the housing 1 are closed, two spherical chambers 11 are formed and the interior face of one of the spherical chamber 11 is a slot 111, and the chamber 11 with the slot 111 is for the holding of the crystal ball 2 mounted with the rib rim. The housing 1 is provided with a plurality of bands 12 for binding.

In accordance with the present invention, the rib rim 3 is formed as one unit and is very strong. The internal diameter is smaller than the largest diameter of the crystal ball 2. A tool (not shown) is used to fit the rib rim 3 onto the largest diameter of the crystal ball 2 such that the crystal ball 2 is provided with a permanent circular pressure. When two crystals balls 2 are placed into the spherical chambers 11 and are covered, the two crystal balls 2 are aligned axially to the slot 111. Finally, a binding band passed through the bands 12 and is secured at the cathode of a battery.

With the application of the rib rim 3, the crystal ball with not be affected by any external factor so that the compression to the crystal ball is maintained. After the housing 1 is mounted, ultra sonic method or other sealing methods are employed to seal the housing 1. The compressed crystal ball 2 together with the influence of the magnetic field, a stable and constant magnetic field with respect to the axial direction of the rib rim 3 is formed; with this effect, the distorted waves of electric loops can be eliminated and the changes of the loops are stable. This will improve the micro-computer operation of the vehicle, and this will increase the sensitivity of the throttle of the vehicle. Therefore, the starting power of the engine is improved and the fuel consumption is decreased.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A crystal ball enclosure comprising a housing having at least one spherical chamber, at least one crystal ball and rib rim as the spherical chamber holding the crystal ball, characterized in that the interior face of the spherical chamber is provided with a slot, and the rib rim is strong and is formed as one unit and is firmly compressed as the largest diameter of the crystal ball and the crystal ball with the rib rim is placed in the slot of the spherical chamber.

2. The crystal ball enclosure of claim 1, wherein the circumferential of the housing is provided with at least one band.

3. The crystal ball enclosure of claim 2, wherein the spherical chamber is aligned at axial position to the slot.
